(19) United States
(12) Patent Application Publication
(10) Pub. No.: US 2016/0191558 A1
(43) Pub. Date: Jun. 30, 2016

(54) ACCELERATED THREAT MITIGATION SYSTEM

(71) Applicant: BRICATA LLC, Vienna, VA (US)

(72) Inventor: Iain Martin Devere DAVISON, Clinton, MD (US)

(21) Appl. No.: 14/581,136

(22) Filed: Dec. 23, 2014

(51) Int. Cl. H04L 29/06

(52) U.S. Cl. CPC H04L 63/1425; H04L 63/145; H04L 63/1416; H04L 63/20; H04L 63/062

(57) ABSTRACT

An intrusion detection and prevention system and method for dealing with threats to computers and computer networks, and in particular to computers and networks connected to the Internet, is disclosed. A sensor receives network traffic. The sensor includes a first processor for managing the network traffic that is received, a first path for the traffic that is received for storing the traffic in a memory for subsequent use, a second path for analyzing the traffic that is received, and for processing the traffic at a speed that is at least as fast as speed of the first path. The second processor is associated with the second path so that some of the traffic is allowed along the first path and other of the traffic is rate limited or not allowed along the first path. The system and method use four tiers of threat detection to successively mitigate a large variety of threats.

This application claims priority from provisional patent application Ser. No. 62/018,249, filed on Jun. 27, 2014, which is incorporated herein by reference, in its entirety, for all purposes.

### BACKGROUND OF THE DISCLOSURE

1. Field of the Disclosure

The present disclosure relates to systems and methods for dealing with threats to computers and computer networks, and in particular to computers and networks connected to the Internet.

2. Description of the Related Art

While the Internet has enhanced the lives of a huge number individuals, and has often been of great importance to businesses by facilitating e-commerce, the Internet also raises significant threats to the integrity and continued existence and security of data stored on computers and computer networks. Viruses, spyware, worms, so called ransomware and other threats abound. Computer systems and networks are often under almost constant attack by individuals or criminal organizations seeking to breach security measures and either steal confidential data, or maliciously destroy data or operating capability, at least on a temporary basis, by denial of service and other attacks.

There are a number of products on the market designed to mitigate the risk of attacks. Antivirus software and other threat mitigation packages, including software and hardware, are ubiquitous.

A problem associated with these products is that they generally do not offer the speed required to analyze and react to various threats on a virtually real time basis. The user will often notice that browsing or system response times are increased when these threat mitigation tools are used. Further, in situations where large amounts of data must be evaluated on an ongoing basis, these tools simply cannot keep up with the flood of data. Data packets must either be dropped, or simply not analyzed and allowed to reach the system. In the first case valid traffic may be missed. In the second case, the computer or network will be exposed to threats.

A further difficulty is that in using conventional threat mitigation tools, threats may be detected, but such detection may not occur in a timely fashion to prevent a computer or system from being infected. It may be necessary to spend hours recovering programs or data from a backup system, assuming that a backup is available.

Intrusion Detection and Prevention Systems (IDPS) analyze network traffic for malicious activities and report findings from events that can compromise the security of computers and other equipment. Such systems look into both headers and payloads of the network packets to identify possible intrusions.

IDPS models that only use Central Processing Units (CPU) such as the Snort intrusion detection system (IDS) have in the last decade struggled, though, as the CPU has become a system bottleneck. Network traffic has increased more rapidly than CPU clock-speed. Although CPUs have gained more cores, they lack a method for multi-core implementation and are unable to cope with the bandwidth throughput that is now seen in the network infrastructure that they are designed to protect.

As noted above, massive flows of data packets overload the network intrusion detection system (NIDS) and lead to packet loss, allowing them to pass by unchecked for malware and intrusion attempts and increasing the false-negative rate. The main cause of this is the network packet inspection module in the detection engine of the NIDS. The detection engine consists of numerous functions and ultimately contains an algorithm for string searching.

In the recent years modem Graphics Processing Units (GPUs) have evolved from a tool that only displays high-end graphics for games, into a tool for general-purpose scientific and engineering computing across a range of platforms. “GPU computing” is the term used when ordering the GPU to take over and accelerate the computationally-intensive calculations normally done by the CPU, letting the CPU take care of the more sequential parts of the application. The CPU and GPU then work together solving tasks in a heterogeneous co-processing computing model. The GPUs have grown exponentially in processing power and memory bandwidth. The requirement for multi-threaded, multi-core technology has grown as networks are continuing to get bigger, with larger bandwidth, internally and externally.

By offloading the work from the CPU to the GPU, the systems can perform massive amounts of parallel calculations and gain high enough performance to reduce or completely eliminate packet loss.

Many approaches have attempted to take parts of IDPS and split them into elements for basic multithreading parallelism realized by normal CPU multi-core processors. Attempts at accelerating IDPS through special hardware other than a CPU have also been made for years. Application-Specific Integrated Circuits (ASIC) or Field-Programmable Gate Arrays (FPGA) chips can be designed and programmed solely to run a single algorithm or a small system. Both methods were quite fast, but found to be extremely expensive in implementation. Further, speed limitations allow them to only provide a single fast lane of processing, even when placed in a distributed model where an aggregator would essentially spray the traffic across multiple FPGAs to gain more speed. Chip circuits such as FPGAs also have the downside that when changing a rule or adding a new rule set, one must program an entire new circuit and then recompile the entire automaton, thus limiting the overall life span of a device that is often sold at a premium.

### SUMMARY OF THE DISCLOSURE

Thus, there is a need for an accelerated intrusion detection system. Such a system should allow for real time packet analysis, and allow an analyst to display and review threats in a number of appropriate formats.

To use the GPU, it is necessary to determine what data should be processed on the GPU rather than the CPU since the GPU will only give performance boots at tasks that can be done in parallel. Sequential processing would still be done far better by the CPU.

The approach disclosed herein offloads the traffic directly to the parallel processing engine while running multiple GPU's and thousands of cores. This approach addresses large amounts of traffic in a short period of time while maintaining the state of the traffic and applying policy and rules to it.

Further, the approach disclosed herein allows the processing to be tuned to process more traffic while providing deeper analysis.

The system disclosed herein introduces methods for threat/network intelligence sharing between peers. Using the spare cycles on the tier 1 IDPS sensors to perform some of the analytics using dynamic cryptographic tables, works not only for a single entity or organization solving a correlation problem of a large dataset, but also for organizations that have may have partnering agreements and need to share the larger correlation analysis across external entities. This also allows for a community blog and threat analysis community to assist and aid with correlation assistance.

Also addressed is the issue of attribute based access controls (ABAC) and role base access controls (RBAC) correlated events. These events are often overlooked by many technologies. A decision engine can be associated with the correlated events and can make decisions based on events, traffic and data exfiltration to outbound sources including GEOIP-defined locations that are customized based on net blocks and ranges, as defined by a user.

The system can have many different implementation models that allow for flexibility in cloud environments that allow the customer to purchase it from the market place directly and add it to their pool of available resources. This can grow with the user's needs. For example, if the user starts with offering small amounts of data over limited connectivity and that need suddenly grows (many cloud providers offer a means to dynamically grow the resource capacity) the system can be scaled in accordance with the functionality that is needed.

With on-board secure socket layer (SSL) decryption, combined with the use of a dedicated data bus memory, direct GPU I/O can achieve a fast-fast data path solution while many other solutions can only achieve a fast or a fast-slow path. The fast-fast path enables the disclosed system to provide extremely high speed and performance in the form of IDPS

In accordance with one aspect, the system for protecting against internal and external based network threats, comprises a sensor for receiving network traffic, the sensor including: a first processor for managing the network traffic that is received; a first path for the traffic that is received for storing the traffic in a memory for subsequent use; and a second path for analyzing the traffic that is received, the second path processing the traffic at a speed that is at least as fast as speed of the first path. A second processor is associated with the second path for processing the traffic so that a first portion of the traffic is allowed along the first path for subsequent use and a second portion of the traffic is rate limited or not allowed along the first path.

The second processor is a parallel processor for executing a multitude of threads to analyze the network traffic for threats, the parallel processor distributing the network traffic to the threads, the parallel processor executing four tiers of processing including: a first tier as a physical layer for preliminary inspection of the network traffic; a second tier for distribution and load balancing of traffic to the threads, and for dropping traffic due to IP headers from sources that are not reputable of originating in certain locations; a third tier for performing analysis of network traffic based on rules, heuristics and policy considerations; and a fourth tier for performing deep packet inspection and analysis.

The system can further comprise a control management center for periodically receiving data from said sensor representing all of the network traffic, during a predetermined period of time. The control management center can receive data from a plurality of sensors. The plurality of sensors can all be associated with the same enterprise.

The system can further comprising a database for storing and indexing data received from the sensor by the central management console. The system can also further comprising an analytic module for running queries against the database.

The system can further comprise a crypto vault containing a set of keys for decryption of data received by from the network. A TPM chip can be initialized by a private key to access the crypto vault.

The system can further comprise application analytics for receiving and organizing data from the memory; a presentation application program interface for processing data from the application analytics; and a web utility for allowing an user to interact with the application analytics via the presentation application program interface.

In accordance with another aspect, the disclosure is directed to a method of for protecting against Internet based threats, comprising: receiving network traffic; sending the network traffic along a first path, the traffic being stored and available for subsequent use; sending the network traffic along a second path for analyzing the traffic that is received, the second path processing the traffic at a speed that is at least as fast as speed of the first path; and processing the traffic that has been stored so that a first portion of the traffic is allowed along the first path for subsequent use and a second portion of the traffic is rate limited or not allowed along the first path.

The method can further comprise: executing a multitude of threads to analyze the network traffic for threats; distributing the network traffic to the threads; conducting a multi-tiered analysis of the network traffic using: a first tier as a physical layer for preliminary inspection of the network traffic; a second tier for distribution and load balancing of traffic to the threads, and for dropping traffic due to IP headers from sources that are not reputable or originate in certain locations; a third tier for performing analysis of network traffic based on rules, heuristics and policy considerations; and a fourth tier for performing deep packet inspection and analysis.

The method can further comprise periodically receiving data from the sensor representing all of the network traffic, during a predetermined period of time. The method can also further comprise receiving data periodically from a plurality of sensors. The plurality of sensors can all be associated with the same enterprise.

The method can further comprise storing and indexing data received from the sensor in a database. The method can also further comprise running queries against the database.

The method can further comprise: storing a plurality of keys in a crypto vault; accessing the keys; and using the keys to decrypt the network data. A private key can be used to access the crypto vault.

The method can further comprise: receiving and organizing data from the memory; processing the data for display; and allowing a user to interact with the displayed data.

### BRIEF DESCRIPTION OF THE DRAWINGS

FIG. 1 is a block diagram of a threat mitigation system in accordance with the disclosure.

FIG. 2 is a diagram of an architecture in accordance used in the parallel processing engine of FIG. 1.

FIG. 3 is a flow chart of the analysis tiers performed by the parallel processing engine of FIG. 1.

FIG. 3A is a packet flow block diagram of the analysis tiers of FIG. 3.

FIG. 3B is a flow chart of the steps executed by a tier of FIG. 3.

FIG. 4 illustrates the manner in which keys are securely stored and utilized.

FIG. 5 is a flow chart representative of the manner of analyzing and displaying threat data.

FIGS. 6 through 11 illustrate the manner in which data is displayed on a typical web user interface of FIG. 1.

A component or a feature that is common to more than one drawing is indicated with the same reference number in each of the drawings.

### DESCRIPTION OF THE PREFERRED EMBODIMENT

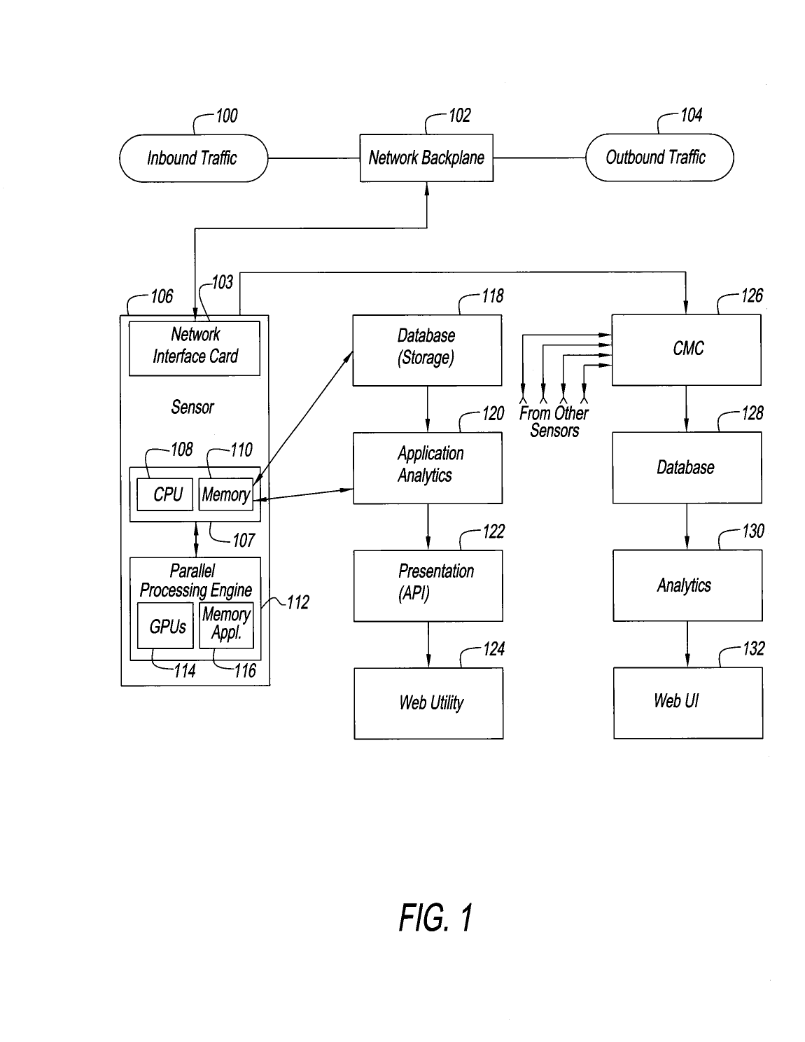

Referring to FIG. 1, a source of inbound Internet traffic 100, is connected to a network backplane 102 of an organization's computer network. The backplane 102 is also a source of outbound traffic 104 from the organization to the Internet.

An Internet traffic sensor 106 is used to acquire both inbound and outbound packets and to inspect the packets for threats to a computer system of which the network backplane 102 is a part. Sensor 106 is connected to network backplane 102 by a network interface card (not shown) having multiple Ethernet connections to capture network traffic. Traffic sensor 106 includes a first computer system 107 comprising a CPU 108 and a memory 110. Memory 110 includes an operating system for CPU 108 and a set of programs, the operation of which is more fully described below.

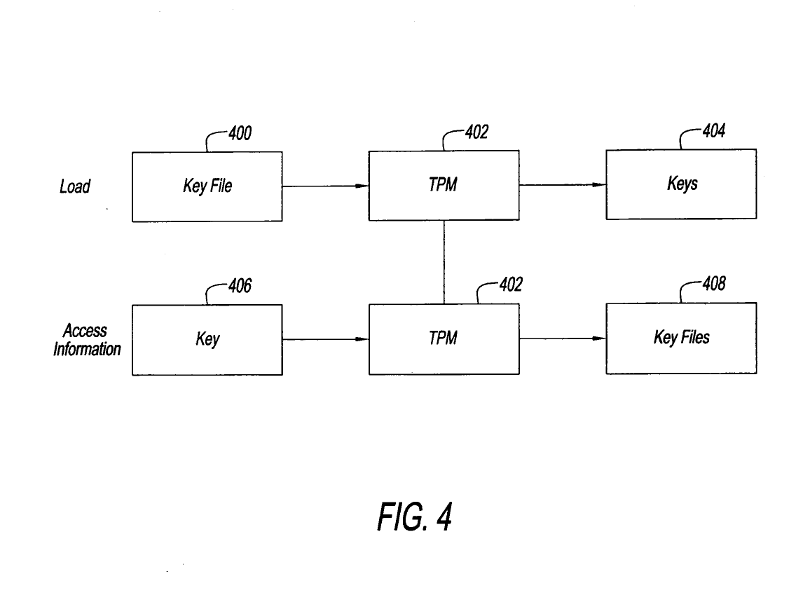

CPU 108 can include a 64 MByte HDD cache memory. Preferably, it is a Trusted Platform Module (TPM) chip or interacts with a TPM chip (not shown), and enables the use of a crypto hardware vault, as described below with respect to FIG. 4. CPU 108 also manages I/O functions and power.

Memory 110 can be of the ECC (Error Correction Control) type. Software stored in memory 110, in addition to the operating system, includes software modules for operation of the network interface card (not shown), packet capture, transfer of netflow to data to storage, a graphical user interface for the sensor 106, analysis of GeoIP data to determine locations, initial I/O load balancing and distribution to parallel processing by the parallel processing engine 112 described below, communication to a Control Management Center (CMC) 126 described below, SSL decryption and a vault key for decryption keys in a crypto hardware vault. This is performed via the local system console at time of setup.

As noted above, it is generally not possible for CPU 108 to acquire, analyze and process the massive number of data packets coining into an organization from inbound traffic 100. Acquired data packets are distributed from first computer system 107 to a parallel processing engine 112 including a massively parallel set of multiprocessors or GPUs 114. Each of the processors of GPUs 114 can include a large number of individual processors, each having multiple cores and running a multitude of computing threads as directed by applications in a memory 116. It is possible, for example, for up to 100,000 threads, or more, to run in parallel, thus enabling the rapid analysis and processing of virtually all data packets in real time, so as to avoid dropping packets or the passing of packets without analysis. A multithreaded, parallel processing IDS software such as, for example, Suricata (a high performance Network IDS, IPS and network security monitoring engine) may be used by parallel processing engine 112, which may be of the CUDA® variety, available from NVIDIA Corporation of Santa Clare, Calif.

Communication between CPU 108 and parallel processing engine 112 is facilitated by an extra line of code in the kernel of the CPU operating system to allow the communication at the same level. Operating system kernel modification is performed to achieve extended processing capability from mainline CPU to GPU.

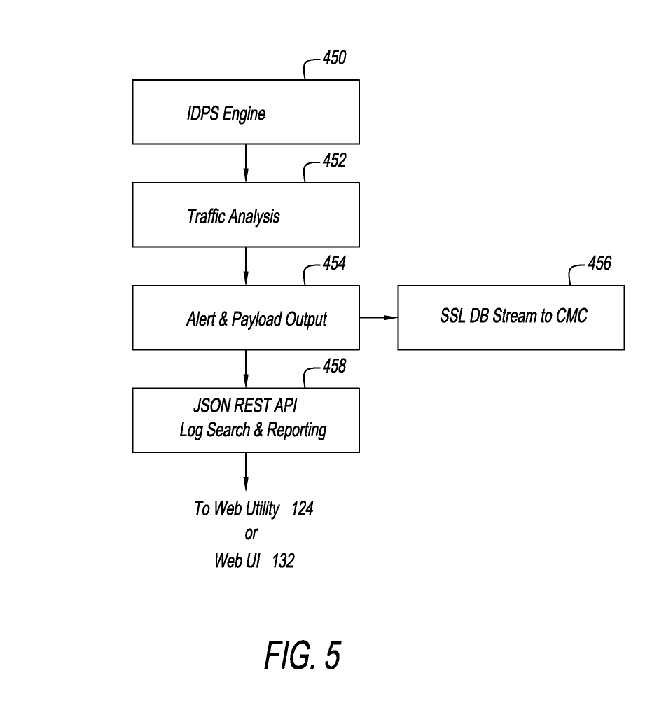

A large database storage 118, preferably based on a solid state memory for enhanced access speed, can store all packets received over a given time period. Selected ones of these data packets, that represent a threat, as determined by parallel processing engine 112 are sent to application analytics block 120. After being analyzed, as described below, a presentation application program interface 122 provides data to a web utility 124. Web utility 124, provided with an input of logged events, presents to a user a simplified dashboard where a user can view a timeline of events on a block to display transport layer security (TLS) traffic, DNS information, or a timeline of all traffic events in a raw format. This also includes a graphical visualization of event types, file types that have been extracted from the network flow while in transit, along with basic searches of the data, that can be conducted. In this regard, reference is made to the discussion of FIG. 5 to FIG. 11 below.

Sensor 106 may be one of many sensors in an enterprise that provides data to a control management center CMC 126. Events of interest (those analyzed to be a threat) are stored in a database 128 (preferably a Cassandra database). The database 128 facilitates queuing of records, indexing the data and the use of crypto tables, as discussed below with respect to FIG. 4, for dynamic exchange of threat information. A user of the system described herein can determine partners or entities with which to share information. The user can determine the amount of information they wish to share such as, just internet protocol information, or they can share more, depending on the level of comfort and the confidentiality with a partner or with an anonymous forum.

The events are analyzed by analytics 130 for GEOIP, attribute role, anomaly detection, rules, heuristics, signatures, times, and packet characteristics such as length, MTU, TTL and sequence. An important aspect of database is 128 is the indexing of data to facilitate analysis by analytics 130.

A web user interface 132, described in more detail below, provides a multifunction dashboard to assist a user or operator in fully reviewing and analyzing threat data.

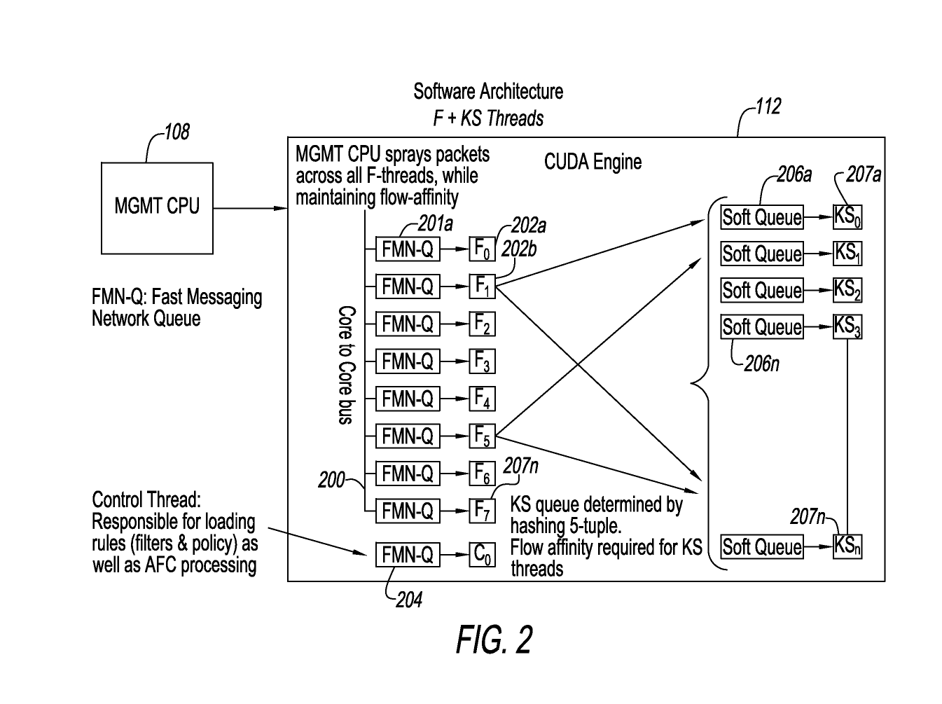

Referring to FIG. 2, the relationship between the CPU 108 and the parallel processing engine 112, in terms of software architecture, is illustrated. CPU 108 distributes packets across all threads of fast messaging network queues 201A to 201N via a core to core bus, while maintaining flow affinity. For each fast messaging network queues 201A to 201N there is a corresponding traffic management (TM) filter 202A to 202N. A control thread 204, also a fast messaging queue, is responsible for loading rules (filters and policy) and processing. Traffic packets are distributed to a series of soft queues 206A to 206N is determined by hashing 5-tuples from the fast messaging queues 200A to 200N, which each feed the slow threads 207A to 207N, respectively. The suffix “A” indicates the beginning of the load balanced distribution of load and the suffix “N” indicates the total number of cores the load is balanced across so as to achieve complete processing performance at speed and with complete accuracy. This is effectively the extensive work of the parallel processing GPUs 114. The data is load balanced across as many cores as necessary to perform the rapid inspection of the traffic at deeper levels and the traffic is either passed through the system successfully, or alerted on and dropped by IDPS.

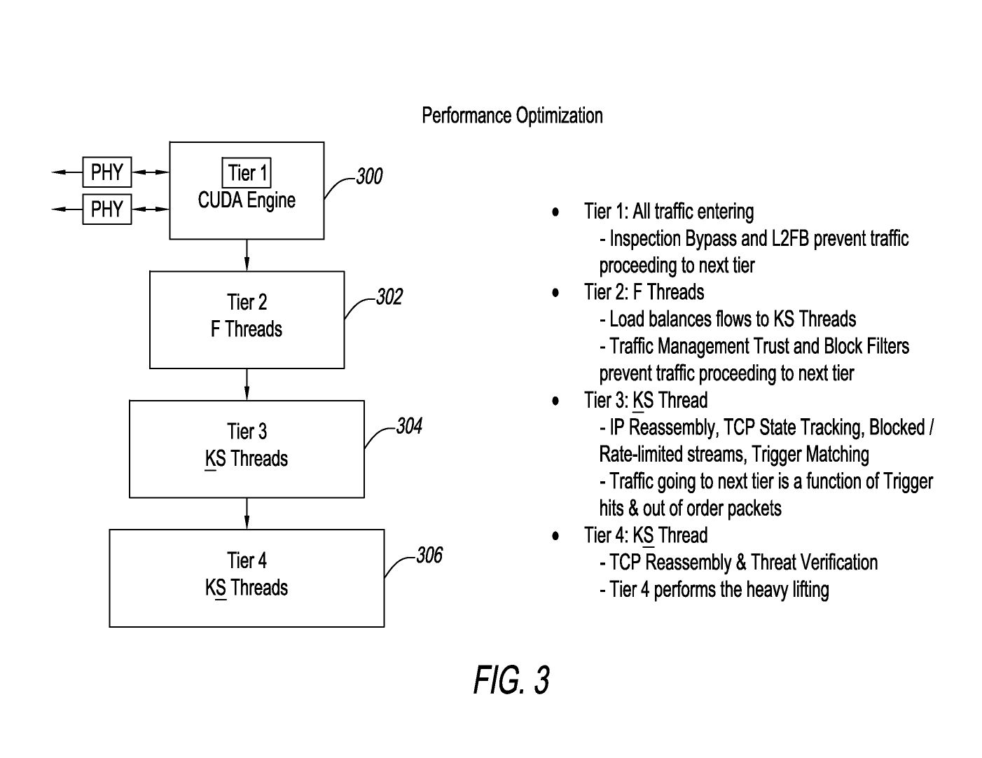

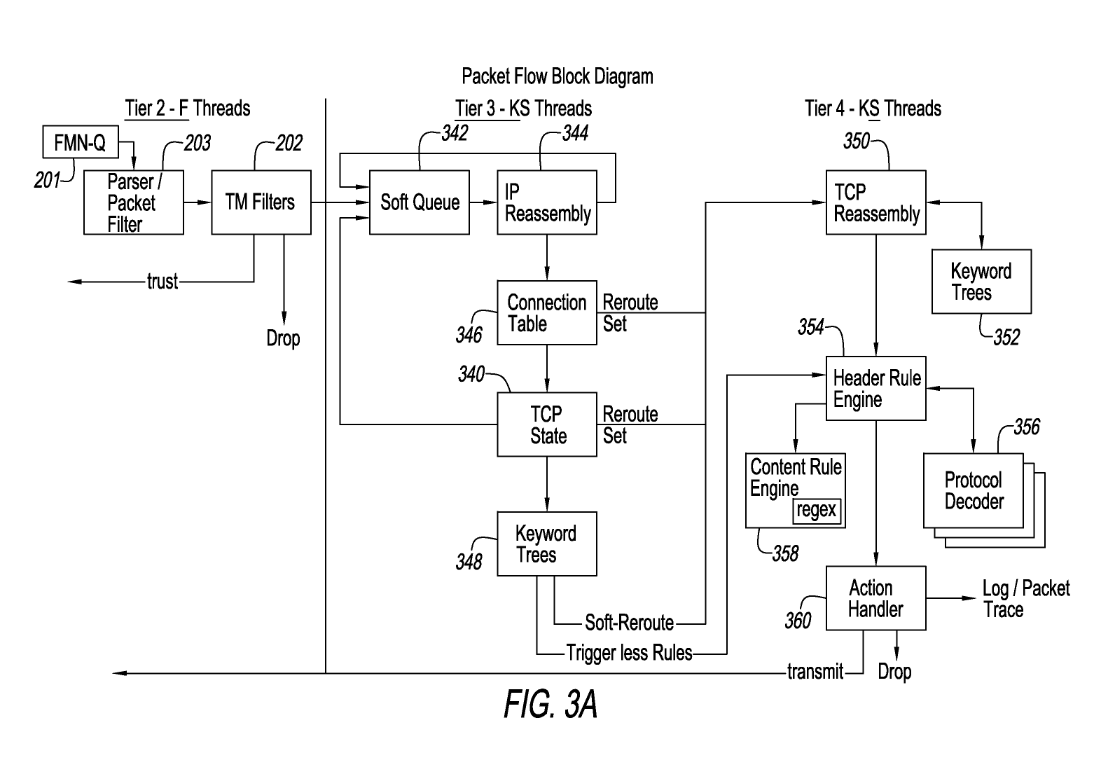

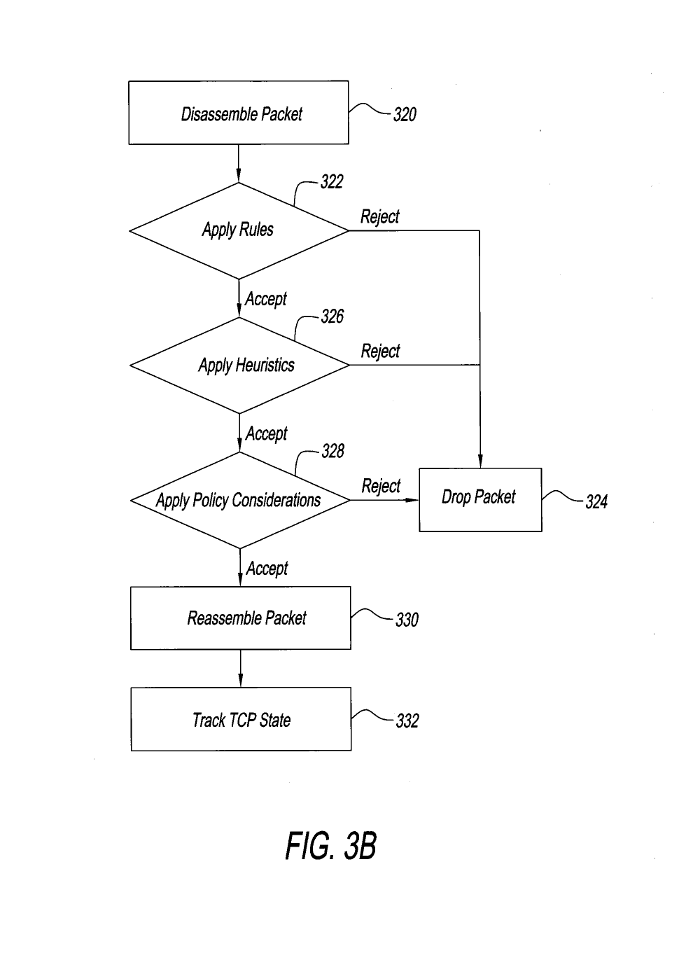

Referring to FIG. 3, performance of the parallel processing engine 112 is optimized by a multi-tiered analysis. Tier 1 300 is the physical layer of the parallel processing engine 112. All traffic enters the engine at layer 2 of the network open systems interconnection project (OSI) model and in the event of hardware failure the traffic enters an inspection bypass also known as a network layer 2 fall back, that immediately passes the network traffic into what is also known as a fail open state. When operating in a normal state, the traffic is ingested from layer 2 of the network stack. Any traffic that is determined to be a threat from proceeding to the next level by dropping those packets. At tier 2 302, load balancing to the KS queues 206A to 206N is conducted. Traffic from some domains may be dropped due to reputation (for example, x.cn addresses) and IP headers based on geographic location (for example, .xxy). In addition, traffic management trust and drop filters prevent threats from proceeding to tier 3. At tier 3 304, analysis is performed using predetermined rules, heuristics and policy considerations to obtain a general idea of the nature of a threat. IP reassembly, TCP state tracking, blocked and limited rate streams are utilized. Packet traffic going to tier 4 306 is limited as a function of trigger hits and out of order packets. Tier 4 306, includes deep packet inspection and analysis, especially of unknown traffic. TCP reassembly and threat verification are performed. Tier 4 306 is the most complex layer.

FIG. 3A provides additional detail with respect to the operation of the tiers discussed above. In tier 2 302, each fast messaging network queue 201 sends packets to a parser/packet filter 203, which then routes the packets to one of the TM filters 202. The various operating threads are fast threads. The threads are independent and stateless in the sense that there is no flow affinity between them. In Tier 2 302, packet header parsing occurs, as updated for IPv6 and for tunneling. Traffic normalization occurs to eliminate incomplete packets, packets with illegal header lengths, and other anomalies. Packets with such anomalies are dropped. The other packets are trusted, or go on for further processing in tier 3. Also occurring in Tier 2 302 is load balancing of flows to the various KS threads 207A to 207N. A TCP/UDP/ICMP/ICMPv6 hash of 5-tuples is conducted. IP fragments are dealt with, for example, by performing a hash of ip.pronto, ipsrc and ip.id. These hashing processes are well known processes associated with Suricata.

Tier 3 304, in general, performs the following steps, as illustrated in FIG. 3B. At 320, packets are disassembled. At 322, detection rules are applied, at which time some packets that meet one or more of the rules, and are thus dangerous, are dropped at 324. Heuristic analysis 326 is applied to the remaining packets. Again, some of the packets are dropped at 324 as being dangerous. At 328, policy considerations are applied, and again, some of the remaining packets are dropped at 324 as being dangerous. At 330, the packets are reassembled. At 332, the TCP state is re-associated with the remaining packets that have passed the tests above and are not deemed dangerous.

Continuing in FIG. 3A, in tier 3 304, the TCP state 340 is sent to a soft queue 342 and then to IP reassembly 344. The reassembly is attempted first, by re-queuing of packets, through a process of looping of traffic through a series of soft-queues to re-construct the specific level of decoded traffic. In some cases this traffic may be too fragmented to re-assemble and/or risk the loss of state, as many attacks are performed in such a slow state that the wait times are broken by the IPS. While the attack is prevented, there are many cases when this isn't the case such as voice over internet protocol, which is somewhat stateless and requires a different type of inspection. Thus, a soft re-route flag is set, and the packet is passed to Tier 4 306 for reassembly, as are packets with TCP sequences that are not authentic. Packets are copied and forwarded and updated if necessary to be compatible with IPv4 and IPv6 formats. When IP reassembly has occurred, packets can be migrated between threads to avoid “hot spotting”, where any given thread is overloaded with too many packets to process in a given amount of time. A reassembled packet can also be rerouted to a different thread for inspection to maintain flow affinity. A connection table 346 checks whether flow of packets is blocked rate limited or marked for a soft reroute, by querying provided policies dictated by the IDPS policy of potential whitelist's and blacklists. Keyword trees 348 search for suspicious traffic which needs to undergo deep inspection in tier 4 306. If trigger matching occurs (certain keywords are found) a determination is made as to what filters 201A to 201N need to be checked against the flow of packets. Software reroute for the flow is turned on, and the packets proceed to tier 4 306.

The somewhat slower processing of tier 4 306 is responsible for TCP reassembly 350. Reassembled flow is sent to a buffer, typically of 32 Kbytes in size, which allows coping and forwarding of the packets. The packets are checked against established keyword trees 352 at a deeper level of embedded inspection that was initially viewable in previous tiers, to eliminate some packets as dangerous. The packets are routed to a header rule engine 354 to conduct header based checks. A protocol decoder 356 does protocol decoding. A content rule engine 358 does content searching without the need to backtrack as the entire packet has been decoded and re-assembled, using regular expression matching (Regex) and Perl Compatible Regular Expressions (PCRE) matching. An action handler 360 does packet disposition by transmitting, dropping or rate limiting packets. Action handler 360 also installs blocks for specific types of packets and specifies rate limits in connection table 346. It also initiates callbacks for logging events of interest, by means of tagging the offending traffic in the packet capture data that is sent to the CMC 126.

In summary, all packet traffic that is not eliminated at tier 3 304 is queued for inspection by tier 4 306 on a first in first out basis. Traffic is distributed across all available cores and rapidly moves on to next steps, as discussed below. The stream of data is processed in the first instance with no logging or output generation so that the process runs at the highest available speed.

After the tier 4 306 analysis, the packets that have not been eliminated as associated with threats are returned to the physical layer for additional processing. The actual analysis is accomplished in approximately 10 microseconds, which is twice as fast as the time for current systems. This rapid processing, facilitated by the massive parallel processing of the parallel processing engine 118, allows for all packets to be processed in most networks, thus avoiding the need to drop packets that pose no threat, and providing the opportunity for all packets to be inspected and analyzed. The system disclosed herein thus provides a fast-fast data stream approach. Data is transmitted at a fast rate along a fast data path (such as 120 Mbytes/second), while analysis is also performed along a fast data path (also at approximately 120 Mbytes/second).

Referring to FIG. 4, SSL decryption is accomplished by CPU 108 using keys stored in a crypto vault. A private key 406 stored in a key file 400 (containing keys for web gateways) is accessed by a TPM chip 402, thus providing access to keys 404. Private key 406 is used to initialize the TPM chip 402 during operation so as to decrypt SSL information by referencing the key against the captured SSL/TLS packets. The arrangement of FIG. 4 helps to minimize key spread, thus making the disclosed system more secure.

Communication of I/O data to the CMC 126 is by way of a stream of metadata and payload data. Metadata includes SRC and PSP metadata for internal domain assets, time and GEOIP data. Data from packet capture is also communicated to the CMC 126.

CMC 126 has two principal functions. Sensor traffic is received and processed if necessary by means of an SSL encrypted SQL stream from the sensor containing the metadata of the event and the associated payload for inclusion in database 128, which can be a SQL database. The data representing the traffic is added to database 128. This includes traffic indexing by source, destination, port, payload, event meta data, sensor from which the data originated, annotated events or notes, date, time, classification and GEOIP. Annotation of events may be for purposes of allowing event selection, event classification and the generation of notes concerning events.

Data stored in database 128 is provided to analytics 130. Data may be analyzed by using pattern matching, aggregation, correlation and attachments associated with events. A soft queue of requests to data records can be established. Multiple indexed tables can be generated. Un-indexed lists can be created for rapid reading from memory. Events can be searched over time within multiple data sets. Payloads and associated alerts can be indexed and searched. Attachments, checksums and associated events can be indexed. In general, time can be the common aggregator and correlation key.

Web user interface 132 can display via the Internet, any of the reports, dashboards, lists or other information generated by analytics 130.

Presentation API 122 generates displays as discussed below. Reports can be generated and printed, and data can be displayed on a dashboard. The data can be sorted and displayed, or reports printed in order of top destinations, top sources, top sensors, protocols, and number of attacks at various severity levels. Further sorting can be done by time, including by day, week, month or year.

FIG. 5 is a block diagram illustrating the general operation of the analysis and display functions of the system of FIG. 1. The IDPS engine 450 (sensor 106 and associated memories 110 and database 118) provide for data analysis at 452. The analysis produces alert and payload output at 454. At 456, alert and payload output is supplied as an SSL database stream to the CMC center 126. Logging, searching are reporting may be done with a JavaScript object notation (JSON) representational state transfer (REST) API at 458 associated with presentation API 122 via web utility 124.

Presentation API 122 allows web utility 124 to run queries against, and create a graphical representation of, IDPS events. Extracted file types and exfiltrated files are shown.

The process is similar for analytics 130 and web UI 132 associated with the CMC and database 128. However, an expanded timeline of events can be created for use in web UI 132 to show the number of events per hour, per day, per week, per month and per year. This can be done for or by event type. Since the CMC can receive data from a number of sensors, reports can be generated aggregating the events detected by different sensors over these time periods. Thus, the user may sort by event type, alert type, source, destination, etc.

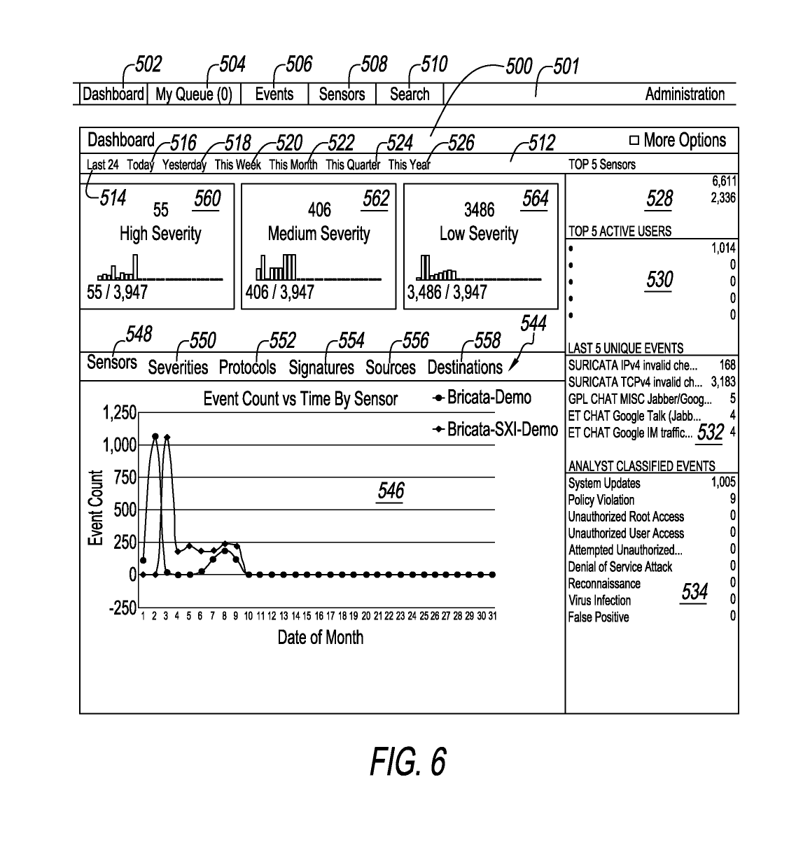

FIG. 6 illustrates a typical dashboard presented to an operator of the system disclosed herein by web user interface 132. A selection can be made by clicking on one of the regions of line 501 to display one of the illustrated dashboard 502, My Queue 504, Events 506, Sensors 508 and Search 510. In FIG. 6, dashboard has been selected. At line 512, a time period for display of the of the last 24 hours 514, today 516, yesterday 518, this week 520, this month 522, this quarter 524 and this year 526 can be selected.

At the right hand side of the dashboard, at 528, the top 5 sensors by number of events counted is listed. At 530, the top 5 active users are listed. At 532, the last six unique events are listed. At 534, analyst classified events are listed. These can include, by way of example, system updates, policy violations, unauthorized root access, unauthorized user access, attempts at unauthorized access, denial of service attacks, reconnaissance events, virus infections and false positives.

On line 544, the contents of a pictorial representation 546, by way of, for example a graph (as a function of time) or a pie chart of events may be displayed. Selections that can be made on line 544 include display by sensors 548, severities (of high, medium and low) 550 and protocol count (all as a function of time). Additional displays in the form of pie charts can be signatures 554, sources 556 and destinations 558 during a period of time selected on line 512, by number, as a percentage of area in a pie chart.

Regardless of the selection on line 544, the events are sorted and displayed by number of high severity at 560, medium severity at 562 and low severity at 564.

In FIG. 6, “sensors” is selected at 548. At 546, a graph of event count verses time for each sensor during the selected time interval is displayed. In FIG. 6, a time period of one month was selected.

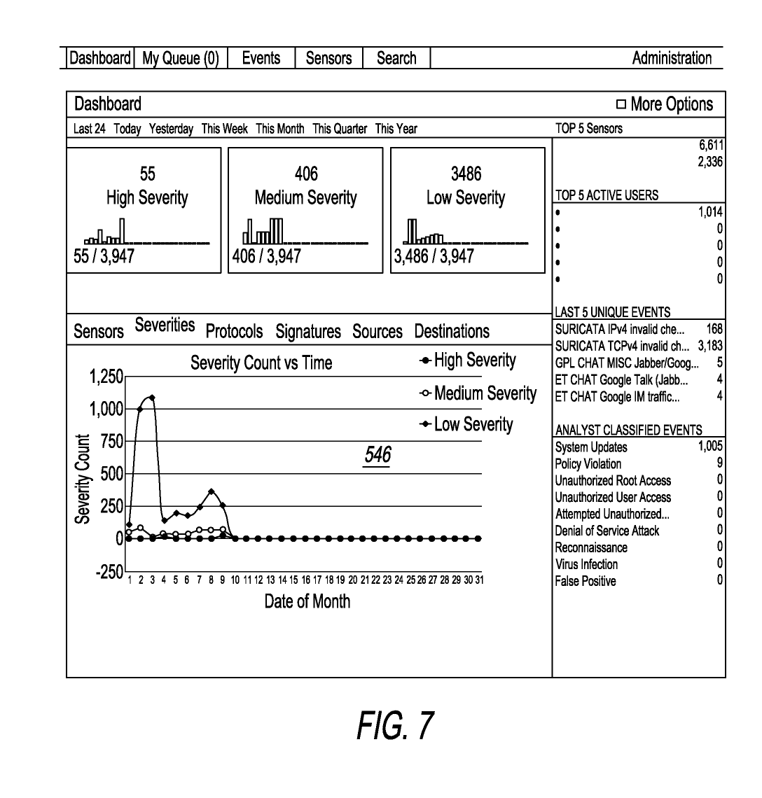

In FIG. 7, “severities” is selected at 550. A graph as a function of time for threats of high severity, medium severity and low severity as a function of time is displayed at 546.

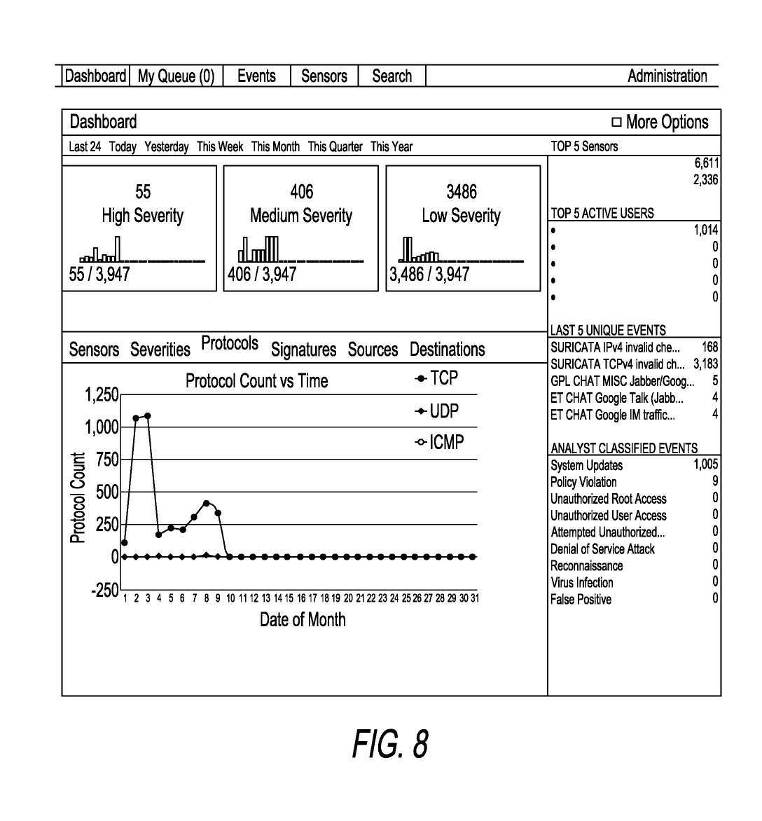

In FIG. 8, “protocols” is selected at 552 and a graph of protocol count verses time is displayed at 546.

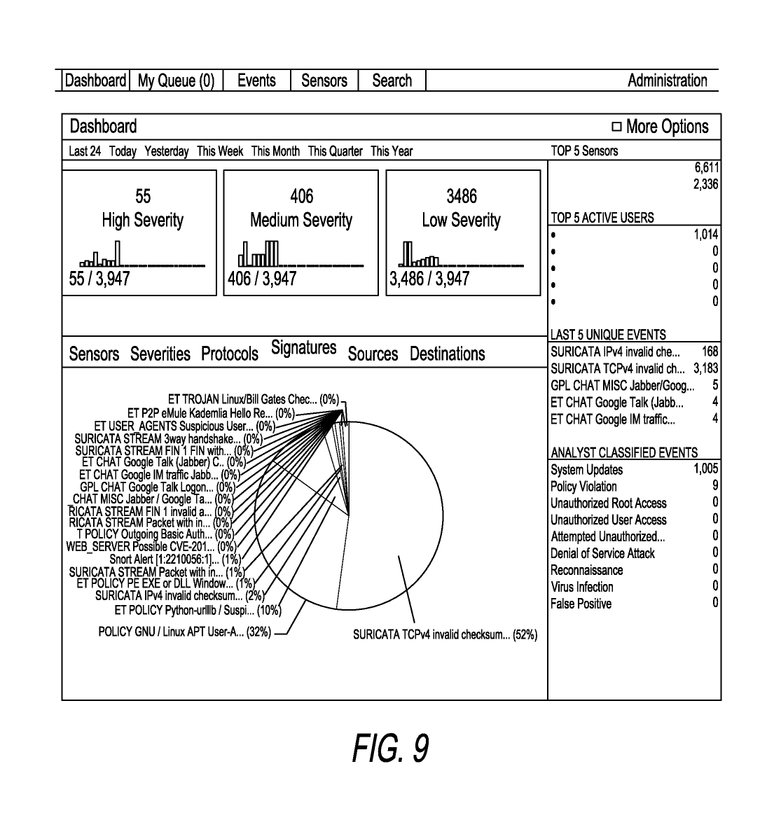

In FIG. 9, “signatures” is selected at 554 and a pie chart of threat signatures during the selected time period is displayed at 546.

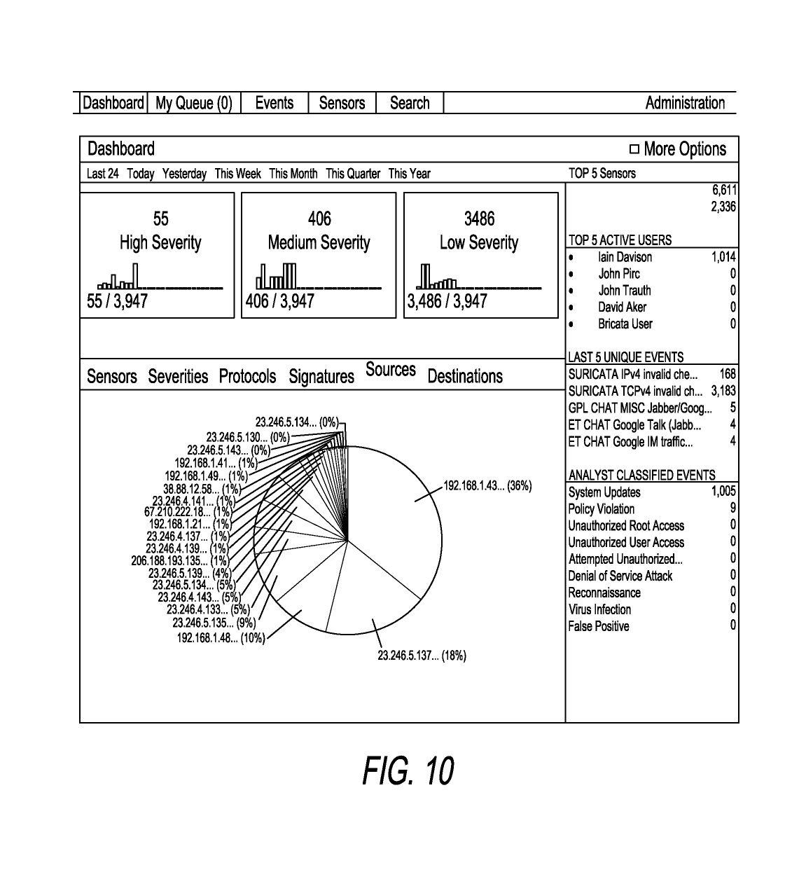

In FIG. 10, “sources” is selected at 556 and a pie chart of threats by source during the selected time period is displayed at 546.

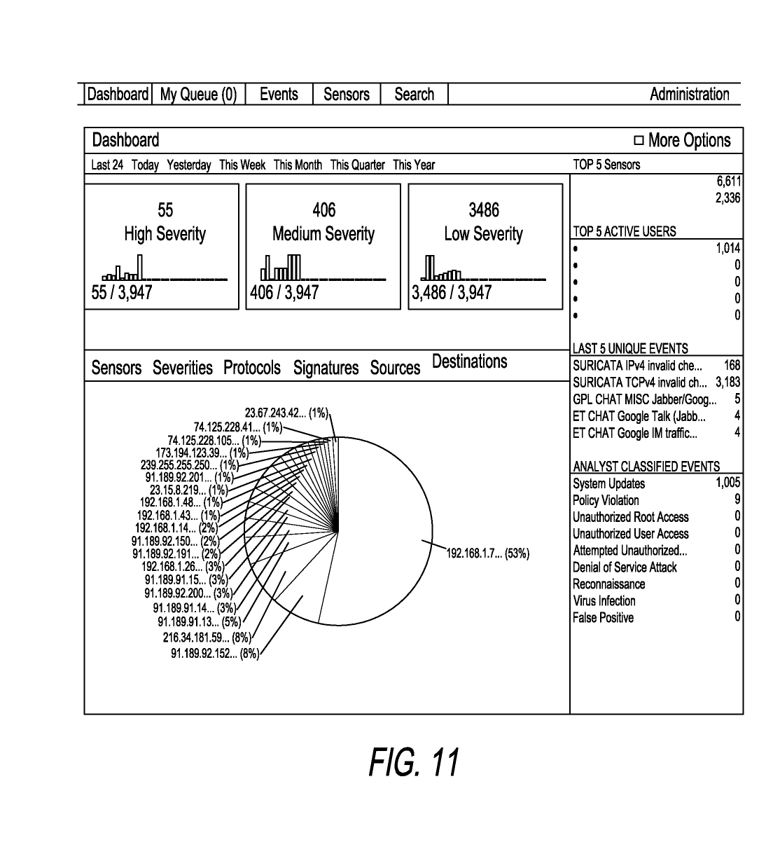

In FIG. 11, “destinations” is selected at 558 and a pie chart of threats by destination during the selected time period is displayed at 546.

Thus, the dashboard provided by the web user interface 132 provides a significant number of displays to allow an analyst to obtain a comprehensive overview of the threat profile as indexed and sorted in a number of ways, thus allowing versatility in treat assessment and analysis.

In addition to the screen outputs described above with respect to FIGS. 6-11, web user interface 132 provides reports of selected data in formats such as PDF or XML format. For example, if desired, it is possible to provide a report of events occurring during a particular period of time, such as 30 minutes, an hour, a day or even several days.

The term “module” is used herein to denote a functional operation that may be embodied either as a stand-alone component or as an integrated configuration of a plurality of sub-ordinate components, including software stored in a memory.

While most of the description herein has been provided with respect to input packets received from the Internet, it will be recognized that outgoing traffic can also be monitored by sensor 106. There are some rare threats that if missed when inbound, cause changes in outbound behavior, such as the transmission of confidential data to an external IP address. Monitoring of outbound packets can note these anomalies so that mitigation steps are taken before large amounts of data have been compromised.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for protecting against Internet based threats, comprising:
a sensor for receiving network traffic, the sensor including:
a first processor for managing the network traffic that is received;
a first path for the traffic that is received for storing the traffic in a memory for subsequent use;
a second path for analyzing the traffic that is received, the second path processing the traffic at a speed that is at least as fast as speed of the first path; and
a second processor associated with the second path for processing the traffic so that a first portion of the traffic is allowed along the first path for subsequent use and a second portion of the traffic is rate limited or not allowed along the first path.

2. The system of claim 1, wherein the second processor is a parallel processor for executing a multitude of threads to analyze the network traffic for threats, the parallel processor distributing the network traffic to the threads, the parallel processor executing four tiers of processing including:
a. a first tier as a physical layer for preliminary inspection of the network traffic;
b. a second tier for distribution and load balancing of traffic to the threads, and for dropping traffic due to IP headers from sources that are not reputable of originating in certain locations ;
c. a third tier for performing analysis of network traffic based on rules, heuristics and policy considerations; and
d. a fourth tier for performing deep packet inspection and analysis.

3. The system of claim 1, further comprising a control management center for periodically receiving data from said sensor representing all of the network traffic, during a predetermined period of time.

4. The system of claim 3, wherein the control management center receives data from a plurality of sensors.

5. The system of claim 4, wherein the plurality of sensors are all associated with the same enterprise.

6. The system of claim 3, further comprising a database for storing and indexing data received from the sensor by the control management center.

7. The system of claim 6, further comprising an analytic module for running queries against the database.

8. The system of claim 1, further comprising a crypto vault containing a set of keys for decryption of data received by from the network.

9. The system of claim 8, further comprising a TPM chip initialized by a private key to access the crypto vault.

10. The system of claim 1, further comprising:
application analytics for receiving and organizing data from the memory;
a presentation application program interface for processing data from the application analytics; and
a web utility for allowing an user to interact with the application analytics via the presentation application program interface.

11. A method of for protecting against Internet based threats, comprising:
receiving network traffic;
sending the network traffic along a first path, the traffic being stored and available for subsequent use;
sending the network traffic along a second path for analyzing the traffic that is received, the second path processing the traffic at a speed that is at least as fast as speed of the first path; and
processing the traffic that has been stored so that a first portion of the traffic is allowed along the first path for subsequent use and a second portion of the traffic is rate limited or not allowed along the first path.

12. The method of claim 11, further comprising:
executing a multitude of threads to analyze the network traffic for threats;
distributing the network traffic to the threads;
conducting a multi-tiered analysis of the network traffic using:
a first tier as a physical layer for preliminary inspection of the network traffic;
a second tier for distribution and load balancing of traffic to the threads, and for dropping traffic due to IP headers from sources that are not reputable or originate in certain locations;
a third tier for performing analysis of network traffic based on rules, heuristics and policy considerations; and
a fourth tier for performing deep packet inspection and analysis.

13. The method of claim 11, further comprising periodically receiving data from said sensor representing all of the network traffic, during a predetermined period of time.

14. The method of claim 11, further comprising receiving data periodically from a plurality of sensors.

15. The method of claim 14, wherein the plurality of sensors are all associated with the same enterprise.

16. The method of claim 11, further comprising storing and indexing data received from the sensor in a database.

17. The method of claim 16, further comprising running queries against the database.

18. The method of claim 17, further comprising:
storing a plurality of keys in a crypto vault;
accessing the keys; and
using the keys to decrypt the network data.

19. The method of claim 18, further comprising using a private key to access the crypto vault.

20. The method of claim 11, further comprising:
receiving and organizing data from the memory;
processing the data for display; and
allowing a user to interact with the displayed data.
